(19) United States
(12) Patent Application Publication
(10) Pub. No.: US 2016/0016375 A1
(43) Pub. Date: Jan. 21, 2016

(54) Tiered Base

(71) Applicants: Frank Gust Erickson, Mobile, AL (US); Dawn Renee Erickson, Mobile, AL (US)

(72) Inventors: Frank Gust Erickson, Mobile, AL (US); Dawn Renee Erickson, Mobile, AL (US)

(21) Appl. No.: 14/797,454

(22) Filed: Jul. 13, 2015

Related U.S. Application Data
(60) Provisional application No. 62/025,383, filed on Jul. 16, 2014.

(51) Int. Cl. B32B 3/08; B32B 27/30; G09F 13/04; A47G 29/30; A47G 19/02; B32B 27/08; B32B 3/26

(52) U.S. Cl. CPC B32B 3/08; B32B 27/08; B32B 27/308; B32B 3/266; A47G 29/30; A47G 19/02; G09F 13/0413; B32B 2590/00; B32B 2451/00; G09F 2013/0445

(57) ABSTRACT

The present invention is a multilayer tiered base for illuminated signs and illuminated cake top decorations, which comprises a center cavity to house a light source and a top aperture cutout that will allow the light to illuminate through. This base has variations as to the shape and the height, with height being variable depending upon number of layers and thickness of the material, and also as to the required height needed in order to house the desired light source assembly. The layers are assembled together in a tiered construction, with each layer placed one above the other, each layer successfully diminishing in size as they stack. The base is freestanding when placed on a flat surface or on a cake surface. A cake decoration or sign may be inserted within the base, or may be placed on top of said base, depending upon the design of said decoration or sign.

### CROSS-REFERENCE TO RELATED APPLICATIONS

This application claims the benefit of priority of U.S. provisional application No. 62/025,383, filed Jul. 16, 2014, the contents of which are herein incorporated by reference.

### BACKGROUND

This invention relates to cake decorating accessories and signs, more particular for portable illuminated cake decorations and illuminated signs.

Cake decorations are often utilized for the celebration of holidays, birthdays, and other festivities to highlight or accent a special occasion cake. Birthdays or weddings are the most common celebrations that utilize cake decorations. Frequently these cake decorations are customized and adorned with special decorations that will complement the special occasion. Once the special occasion has past, cake decorations can be retained as a keepsake that will be cherished for years to come.

Weddings are another venue that can utilize portable illuminated signs. Many brides desire to have a small welcome sign for their guests situated next to their sign in book, table signs for their reception, or even a welcome sign at the head bridal table. Portable illuminated signs can also be used during the reception to highlight the buffet table or bar table during those parts of the reception and dance when the lights are dimmed in the reception hall.

There are many uses for portable illuminated signs. Small businesses utilize signs to direct their customers to a certain location, to relay important information to their customers, or to highlight a special product or service offering. Portable illuminated signs are also an invaluable tool to be used at trade shows and meetings, able to be utilized without the need for electrical connections.

Portable illuminated cake decorations are available on the market today, offering a variety of choices and styles. Portable illuminated cake decorations have started to become very popular in the last couple of years, and offer a way to highlight their cake with a decoration that will draw attention to their centerpiece.

Applicant has experience with prior art in the cake decorating accessories field, having owned and operated a cake decorating business which included extensive experience in the wedding field. Knowledge of deficiencies is from first hand observation and use of prior art. This experience created a desire to solve the problems associated with the deficiencies of prior art.

### DEFICIENCIES OF PRIOR ART

Many of the illuminated cake decorations that are being sold today have designs that are not appealing to the buyer because of the base structure. Typical illuminated cake decorations are characterized by poor designs of the base structure, which either require disruption of the cake itself in order to stabilize the decoration within the cake itself, or by a design that elevates the decoration to sit above the light source thus requiring extra decoration to cover up the space created by the elevation.

Illuminated cake decorations that require a portion of the topper to be recessed into the cake itself present several problems. When the decoration requires disruption of the actual cake it presents a problem of leveling the topper, especially when it is on a soft icing. Many consumers do not want the light source to be inserted into the cake itself because of safety reasons, as the light source will most likely have a battery and electronic connections. Wedding cake top tiers are traditionally kept and stored for a year to celebrate the first anniversary, so most brides do not want their cake disrupted in the manner required for some prior art.

Illuminated cake decorations that require the base to be covered up with other adornments because it is raised and elevated present an inconvenience for the consumer. If the decoration is elevated, then the consumer must use their own imagination to find a way to cover up the empty space created by the elevation.

There are many signs available on the market today for the small business. Many of the signs are housed within very basic bases, with little or no variations. The bases are simple and unadorned, ignoring a possibility of adding a creative touch to their signs. Focus is on the actual sign, rather than creating a complete visual and appealing presentation.

When we first began making our own illuminated cake decorations we could not find a product to house a light source within the base that would allow us to offer customization, be visually appealing, and to not disrupt the cake. We searched many resources in order to locate a premade base that could be used to house a light source and allow us to add our own custom cake decorations and signs, without having to either bury the base inside the cake or to have to create extra decorations in order to cover up the base because it was unattractive. There was no base that we located that would accommodate our needs.

The present invention is advantageous over previous art in that it incorporates the allowance for the insertion of a light source into the interior of a freestanding base, effectively concealing the light source and keeping the power and electronic connections hidden within the base, without disruption of the cake or other confection, and does not require outside decoration to hide a part of this invention. The base is freestanding and presents itself at the same level of a cake, without the need to recess it within the cake itself, nor raise it above the cake level. It allows for complete customization of the shape, height, and potential designs added to the base. This base becomes an integral part of the illuminated cake decoration, and adds to the appeal and functionality of the decoration. The base is also able to be adorned with decoration, as in an engraving design to complement the occasion.

The present invention was originally created for the purpose of our illuminated cake top decorations. The structure of the base has also lent itself to improvement of the visual appeal and options available for portable illuminated signs of all types. It would be a normal observation to understand that this invention would not be restricted to only an illuminated cake top decoration, but could be used for many types of signs.

Prior Art examples are shown below:

U.S. Pat. No. 4,416,075, Nov. 22, 1983 Illuminated Cake Decoration—shows an illuminated cake decoration wherein the battery and electrical components are self-contained, but requires disruption of the cake in order to conceal the components.

U.S. Pat. No. 7,980,475, Dec 17, 2009 Cake Topper Transaction Product—shows a cake topper decoration that requires disruption of the cake in order to secure the decoration.

U.S. Pat. No. 20,150,062,881, Mar 5, 2015 Enhanced Cake Topper—shows an enhanced cake topper that illuminates, with the device positioned inside the cake or other confection.

### SUMMARY OF THE INVENTION

The primary object of the present invention is to provide a freestanding customizable multi-purpose tiered base unit that will accommodate a light source within the interior of the base, and to allow for placement of either a sign or cake decoration constructed of a material that when placed over the light source will allow the light to illuminate the said sign or cake decoration. Said cake decoration or sign may be inserted within the base, or it may be placed on top of said base, depending upon the design of said decoration or sign.

It is another object of the present invention that the base is freestanding when placed on a flat surface or on a cake surface.

It is another object of the present invention that the base is constructed around a light source which could be removable or attached within, which provides easy accessibility and replacement of the light source or batteries as well as a pleasant aesthetic appearance to the user.

It is another object of the present invention to provide such a base that permits the user to select different shapes and heights. This will allow for customization in a way that will complement their sign or cake top decoration needs.

It is another object of the present invention that it allows for the insertion of a light source, which could be removable or permanently attached, so that it is a portable illuminated sign or decoration, useable in all kinds of settings without the need for an electrical outlet.

It is another object of the present invention to provide such a base that can be constructed in a variety of different materials including plastic, wood, glass, metal or other natural or man-made material.

It is another object of the present invention that it is functional without the disruption of a cake in order to hide the light source and electrical connections thus improving upon prior art.

It is another object of the present invention that it is functional without the need to elevate above the cake surface which would require extra decoration to cover up the air space created, thus improving upon prior art.

It is another object of the present invention that it improves upon prior sign art, in that this invention becomes an aesthetically pleasing integral part of an illuminated sign, a base that can be blended in with a sign and provide unlimited possibilities for design in shape, height, material, and decoration.

It is another object of the current invention that varying embodiments may be used to support signs and decorations of many types and is therefore multi-purpose in nature.

### BRIEF DESCRIPTION OF THE DRAWINGS

An understanding of the key features of the invention summarized above may be had by reference to the attached drawings, which illustrate the construction and assembly of several variations of the invention. Such drawings depict only examples and are not considered to be limited in scope to only these examples. There are obvious variations of this invention described herein that are apparent to those skilled in this art.

FIG. 1—is a side view of the preferred embodiment of this invention, depicting a 5 layer, 4 tier base

FIG. 2—is a top view of the preferred embodiment of this invention, depicting a 5 layer, 4 tier base along with a variation of light source assembly, a round LED removable light

FIG. 3—is an angled top view of the preferred embodiment of this invention, depicting a 5 layer, 4 tier base

FIG. 4—is an exploded view of the preferred embodiment of this invention during use as a cake topper on a cake, and showing one possible variation of a light source assembly, a round LED removable light, along with the illustration of a possible cake top decoration inserted into the top of the base

FIG. 5—is a top view of the pattern pieces used to assemble the preferred embodiment of this invention, a 5 layer, 4 tier base

FIG. 6—is a cut out angled view of the preferred embodiment of this invention illustrating the positioning of a variation of a light source assembly within the hollow cavity cutout, along with the illustration of a possible sign or cake decoration being inserted from the top

FIG. 7—is a cross sectional view of the preferred embodiment

FIG. 8—is a top view of another embodiment of this invention, showing a three layer, three tier base which shows another light source assembly variation, an LED light strip

FIG. 9—shows a side view of the same embodiment in FIG. 8

FIG. 10—shows an angled view of the same embodiment in FIG. 8

FIG. 11—is a cut out view of the same embodiment in FIG. 8, illustrating the insertion of a light assembly that includes a rectangular shaped battery pack

FIG. 12—is a top view of the pattern pieces used to assemble the embodiment of this invention that is shown in FIG. 8

FIG. 13—is a top view of another embodiment of this invention, showing a five layer, 4 tier rectangle base

FIG. 14—is a side view of the same embodiment shown in FIG. 13

FIG. 15—is and angled view of the same embodiment shown in FIG. 13

FIG. 16—is a cut out view of the same embodiment shown in FIG. 13, illustration the insertion of a round LED light assembly

FIG. 17—is a top view of the pattern pieces used to assemble the embodiment of this invention shown in FIG. 13

FIG. 18—is a top view of another embodiment of this invention, a two layer mixed shape base

FIG. 19—is a side view of the embodiment shown in FIG. 18

FIG. 20—is an angled view of the embodiment shown in FIG. 18

FIG. 21—is a top view of the pattern pieces used to assemble the embodiment of this invention shown in FIG. 18

FIG. 22—is an angled view of another embodiment of this invention, showing a custom shaped base

FIG. 23—is a side view of another embodiment of this invention showing a 3 tier base that includes different width layers in between the tiers

FIG. 24—is a side view of another embodiment of this invention showing a 4 tier base that includes different width layers in between the tiers

### DETAILED DESCRIPTION OF THE INVENTION

The following detailed description of the invention describes embodiments of the invention that are preferable for a desired intended use. The description is not to be taken in a limiting sense and those skilled in the art will understand reasonable variations of this invention.

The present invention is a multilayer multi-purpose tiered base for an illuminated cake decoration or illuminated sign (5), that is formed in various shapes and heights which has at least two layers made of a resilient material that is wood, plastic, glass, metal or other natural or man-made material, wherein the layers are positioned one above the other successfully diminishing in size to create a tiered structure, a hollow center cavity that is cut out within the base for the purpose of housing a light source that may be LED or another light source, and at least one aperture cutout (2) to allow for the light to illuminate the said sign or cake decoration (5). Said cake decoration or sign may be inserted within the base, or it may be placed on top of said base, depending upon the design of said decoration or sign.

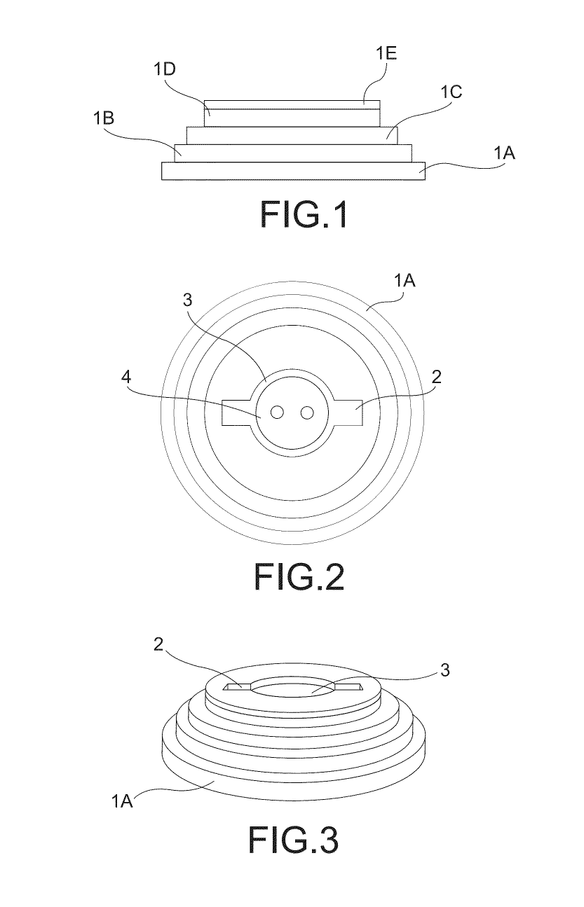

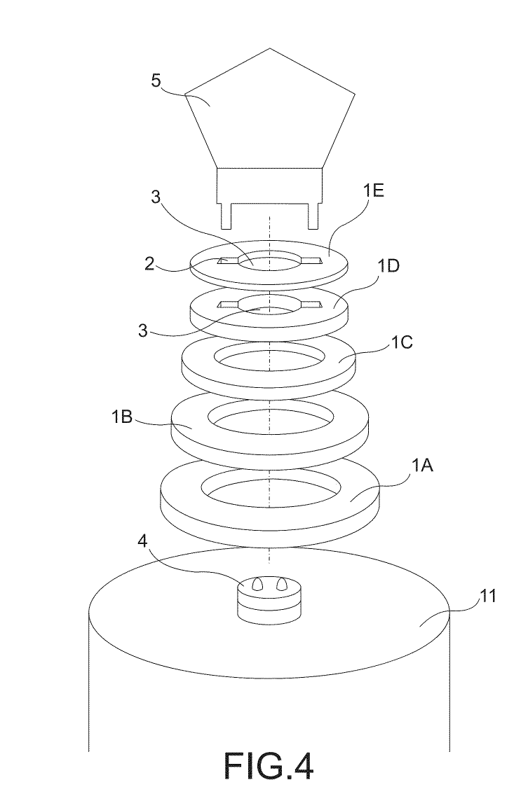

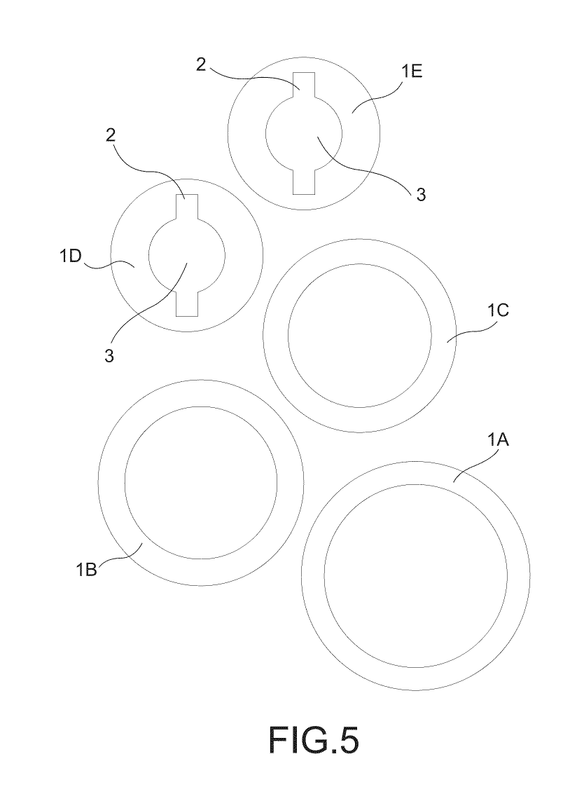

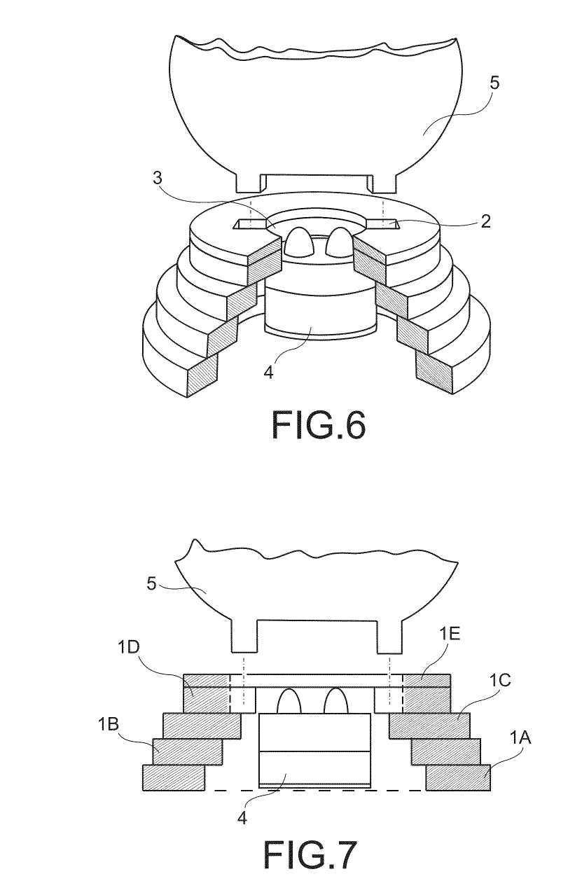

The preferred embodiment of this invention is shown in FIGS. 1 through 7. In FIG. 1, the side view illustrates the layers (1a-1e) of a 5 layer, 4 tier base, where one layer (1e) is the same size as the layer (1d) beneath, so instead of creating another tier it instead adds more height to the tier in order to accommodate the height of the round LED light assembly (4). In FIGS. 2 and 3 the views illustrate the aperture cutout (2) for the purpose of allowing the light from the illustrated round LED light assembly (4) and for the purpose of support and stability of a possible sign or cake top decoration (5), along with the round hollow cavity cutout (3) that creates the cavity to house the round LED light assembly (4). FIG. 4 illustrates how the base is used and assembled as it sits upon a cake (11), with the round LED light assembly (4) being inserted into the bottom of the base with the layers (1a-1e) positioned on upon the other successfully diminishing in size to create a tiered structure, and a possible sign or cake decoration (5) inserted into the top of the base for the purpose of illuminating said sign or decoration. FIG. 5 shows a top view of the pattern pieces used to cut out the layers (1a-1e) in order to assemble this embodiment. FIGS. 6 and 7 show cutout views of this embodiment that illustrate the positioning of the round LED light assembly (4) and the sign or cake decoration (5).

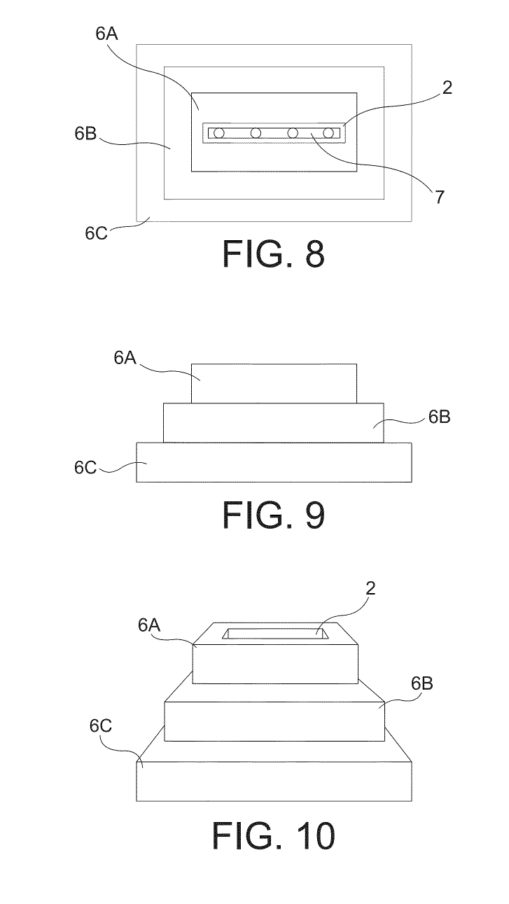

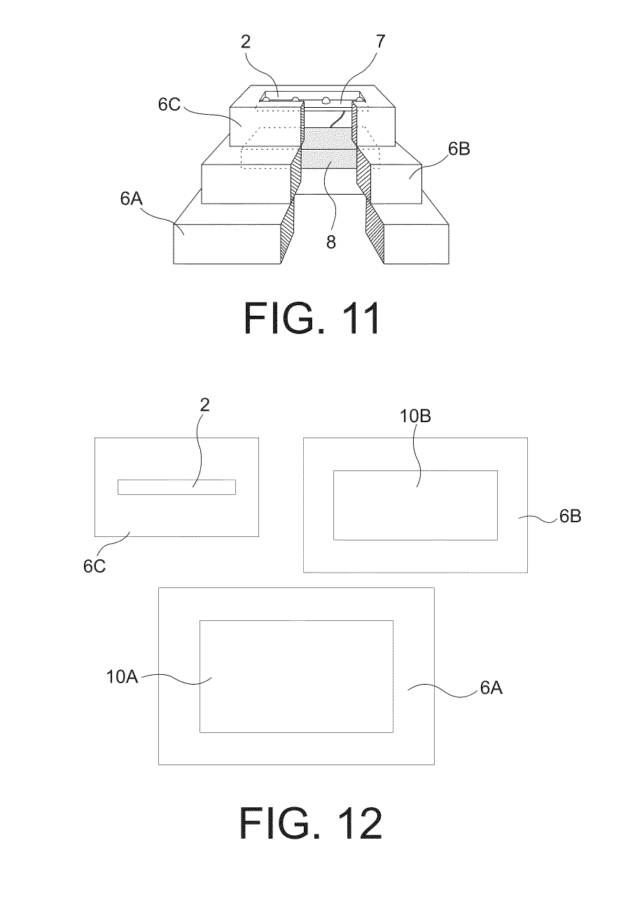

FIGS. 8-12 show another embodiment of this invention. In this embodiment there are three rectangle layers (6a-6c) that include the aperture cutout (2) in the top layer to allow the light to show through from another variation of a light assembly, a light strip assembly (7), and also for support and stability of a chosen sign or cake top decoration (5). FIG. 11 shows a cutout view that illustrates the positioning of this variation of light assembly, a light strip assembly (7) that includes a battery pack (8). The layers (6a and 6b) have a rectangular hollow center cavity cutout (10), creating a frame shape in order to house the rectangular shape of the battery pack (8). FIG. 12 shows a top view of the pattern pieces used to cut out the layers (6a-6c) in order to assemble this embodiment.

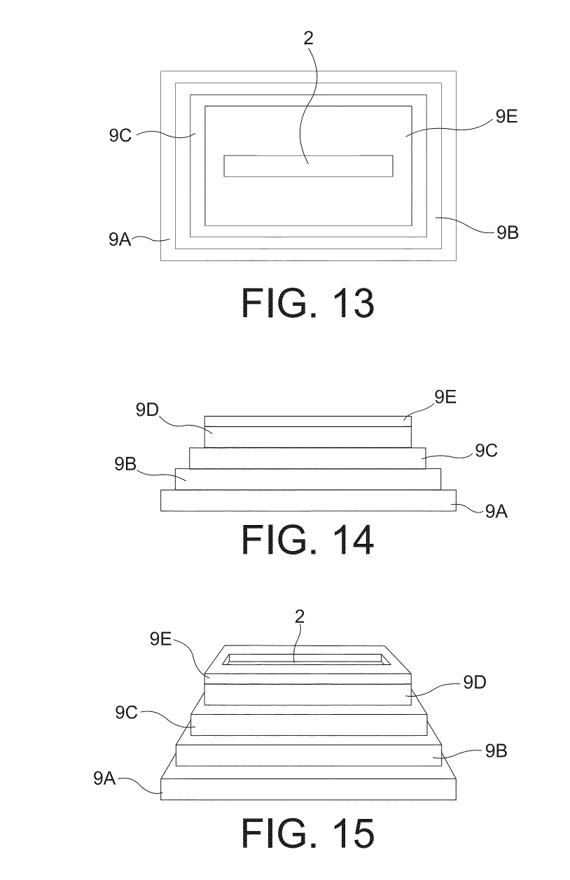

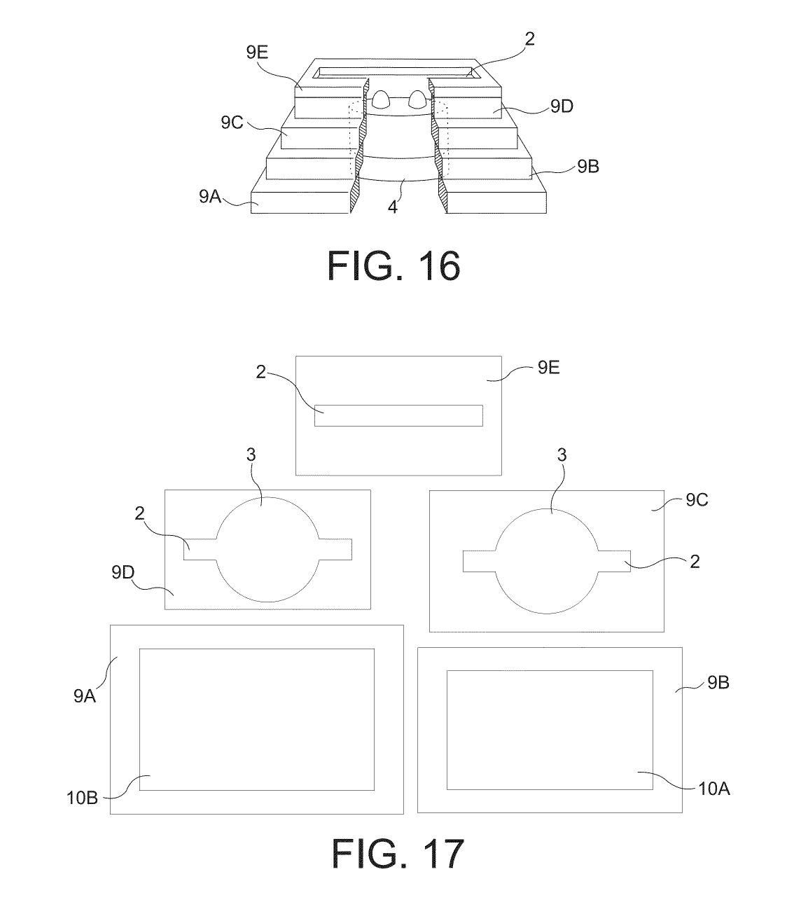

FIGS. 13-17 show another embodiment of this invention. In this invention there are five layers (9a-9e) that create a 4 tier base, where the top layer (9e) is the same size as the layer beneath it (9d) for the purposes of adding extra height to that tier instead of creating another tier. FIG. 16 shows the positioning of the round LED light assembly (4) within the interior of the base, along with the aperture (2) cutout to let the light flow through and to allow for a possible insertion of a sign or cake top decoration (5). FIG. 17 shows a top view of the pattern pieces used to cut out the layers (9a-9e) in order to assemble this embodiment of the invention. Layers (9c and 9d) include a round hollow cavity cutout (3) to house the round LED light assembly (4), while layers (9a and 9b) include a rectangular hollow center cavity (10) cutout. If desired the layers (9a and 9b) could have the round hollow cavity cutout instead (3).

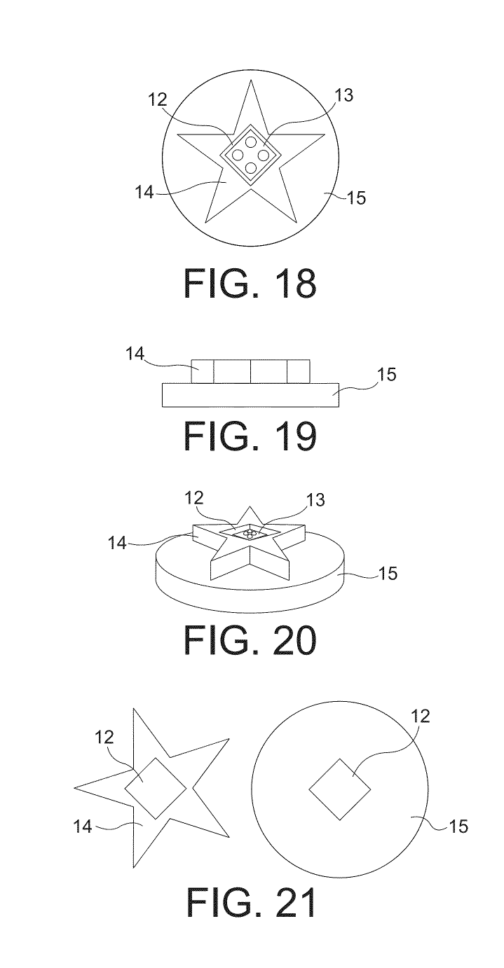

FIGS. 18-21 show another embodiment of this invention, illustrating a two tier mixed shape base. This embodiment comprises a bottom round layer (15) along with a star shaped layer (14), wherein both layers contain a custom shaped hollow center cavity cutout (12) in order to house a custom shaped light assembly (13). This embodiment does not necessarily provide for the insertion of a sign or cake top decoration but allows for a decoration to sit on top of the top star shaped layer (14) and to allow the light to flow through from the custom shaped light assembly (13). FIG. 20 shows an angled view of this embodiment where the custom shaped light assembly (13) is illustrated from the top. FIG. 21 shows a top view of the pattern pieces used to cut out the layers (14 and 15) in order to assemble this embodiment of the invention.

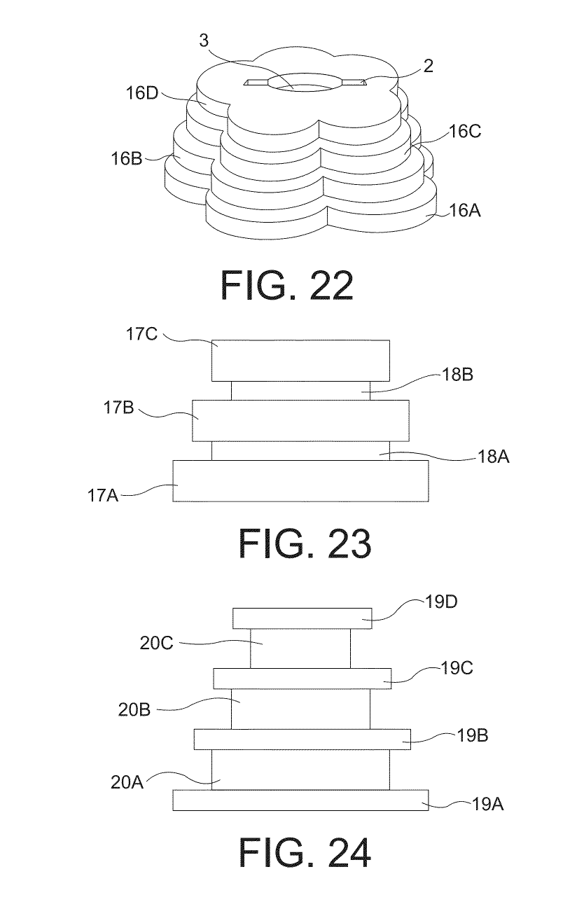

FIG. 22 shows another embodiment of this invention, depicting 4 custom shaped layers(16a-16d) that when positioned one above the other, successfully diminishing in size in order to create a tiered structure. The top layer (16d) includes the aperture cutout (2) along with the round hollow center cavity cutout (3) to house the round LED light assembly variation (4).

FIG. 23 shows a side view of another embodiment of this invention where the 3 layers (17a-17c) are positioned one above the other, successfully diminishing in size in order to create a tiered structure, but also include two extra smaller width and height layers (18a and 18b) that do not deter from the tiered base shape, but add extra height to the base.

FIG. 24—shows a side view of another embodiment of this invention where the 4 layers (19a-19d) are positioned one above the other, successfully diminishing in size in order to create a tiered structure, but also includes 3 extra layers (20a-20c) that are smaller in width but higher than the tiered layer (19a-19d), that do not deter from the tiered base shape, but add extra height and a different look to the base.

The tiered base is constructed of at least two layers of different sizes, placed one above the other and successfully diminishing in size, creating a tiered structure. At least one layer is made with a cutout in the interior of the layer, either with a smaller shape of the design which will form a frame shape, or with the center cavity that is in the shape of the desired light source, or with both.

In certain embodiments, this invention may comprise a third or more layers, with each layer being positioned above the bottom layer, and below the top layer, successfully receding or diminishing in size from the bottom layer, keeping with the tiered construction.

In certain embodiments, this invention may comprise a layer or more than one layer that coincides with the same size as the layer above or beneath it, to provide for extra height in that desired tier, or it may comprise a layer or more than one layer that is smaller in width than the tiered layers to provide for more overall height of the base, and to not deter from the tiered structure.

In one embodiment of this invention, the base is constructed of layers of acrylic plastic in a round or rectangle shape, which contains a hollow cavity cutout within of a round or rectangular shape to accommodate a replaceable LED light assembly, and measures less than 6 inches wide and less than 5 inches high.

In certain embodiments, this invention may contain a hollow center cavity cutout within at least one layer and more than likely more than one layer, in the shape of a rectangle or other shape in order to accommodate a rectangular shaped light source assembly.

The tiered base contains a center cavity within at least one of the layers to accommodate a light source, along with at least one aperture cutout in the top layer. The top layer may or may not contain the center cavity, but it will contain at least one aperture cutout to allow for the light to illuminate through.

The tiered base is freestanding when placed on a flat surface or on a cake surface, hiding the light source within the interior of the base.

Regardless of the shape that the tiered base takes on, it will include the center cavity for the light source and aperture cutout within at least one of the layers, and could be in all of the layers.

The tiered base can be made of different shapes; examples include round, rectangle, heart, oval, octagon, or any custom design, and the base may include layers that are constructed all in the same shape or any combination of these.

The layers of construction can be made from various materials; plastic, wood, glass, metal, or other natural or man-made material. The layers of the tiered base will be attached together with an appropriate glue, solvent, or method depending on the material of construction.

The layers of construction can be made from a different thickness of each material, with the end product being at least whatever height is required to house the light source, or higher if desired.

Custom decorative designs can also be etched or carved into the layers to offer an unlimited amount of choices. These designs are for cosmetic purposes only and have no bearing on the actual construction of the tiered base.

Having thus described this invention with specifics, it is obvious that various modifications can be made to the shape, height, and material choices without departing from the intended use or scope of this invention.

The embodiments of the invention in which an exclusive property or privilege is claimed are defined as follows:

1. A tiered base for illuminated cake decorations or illuminated signs comprising:
a bottom layer,
a top layer that is smaller is size than the bottom layer,
an aperture cutout, located in at least the top layer to provide for the opening for light to show through, and
a hollow cavity cutout within at least one layer to enclose a light source.

2. The tiered base in claim #1, comprising an extra layer or a plurality of layers in addition to the top layer and bottom layer, each layer being placed one above the other and the layers successfully recede or diminish in size, wherein the layers are secured together to create a tiered structure.

3. The tiered base in claim 2, wherein the plurality of layers are constructed of plastic, wood, glass, metal, or other natural or man-made material.

4. The tiered base in claim 3, wherein the shape of the plurality of layers includes round, oval, rectangle, heart, octagon or any custom shape, and that the base may include layers that are constructed all in the same shape or any combination of these.

5. A tiered base to provide for the illumination, support, and stability of a sign or cake decoration, comprising:
a plurality of layers constructed of plastic, wood, glass, metal or other natural or man-made material, with said layers being placed one above the other and successfully receding or diminishing in size, wherein the layers are secured together to create a tiered structure,
a hollow center cavity created by a cutout within at least one layer and possibly in all layers, in the shape of the desired light source shape or a cutout within at least one of the layers and possibly more than one layer in a smaller size of the shape of the layer thus creating a frame shape in that layer, or a combination of some layers having the frame shape cutout and some layers having the shape of the light source cutout, and
an aperture cutout in at least the top layer and possibly in more than one layer, in an appropriate size and shape for the chosen sign or cake decoration, for the purpose to provide the opening for the light source to illuminate the said cake decoration or sign, and to provide support and stability of said sign if needed.

6. A tiered base in claim 5, wherein the plurality of layers are constructed of acrylic.

7. A tiered base in claim 6, comprising a hollow center cavity in a round or rectangle shape in at least one of the layers to provide for housing of a portable replaceable light assembly or for a permanently attached light source assembly.

8. The tiered base in claim 7, wherein the shape of the plurality of layers includes round, oval, rectangle, heart, octagon or any custom shape, and that the base may include layers that are constructed all in the same shape or any combination of these.

9. A multi-purpose tiered base for providing illumination, support, and stability of a possible sign or cake decoration, that is free standing when placed upon a hard surface or cake surface, created of a resilient material, and provides for the accommodation of a desired light source assembly within the interior cavity of the said base for the purpose of illuminating said sign or cake decoration, comprising:
a plurality of layers constructed of plastic, wood, glass, metal or other natural or man-made material, each layer being placed one above the other and successfully receding or diminishing in size, wherein the layers are secured together to create a tiered structure,
a hollow center cavity created by a cutout within at least one layer, in the shape of the desired light source shape or a cutout within at least one of the layers in a smaller shape size of the shape of the layer thus creating a frame shape in that layer, and
an aperture cutout in at least the top layer to provide the opening for the light source to illuminate the said cake decoration or sign, and for the purpose to receive the insertion of said sign or cake decoration if desired.

10. The multi-purpose tiered base in claim 9, further characterized by having 3-5 layers that are constructed of acrylic.

11. The multi-purpose tiered base in claim 10, further characterized by a round shape of the outside edge of the layers.

12. The multi-purpose tiered base in claim 11, further characterized by comprising a round or rectangle hollow center cavity to house a replaceable light source assembly.

13. The multi-purpose tiered base in claim 12, further characterized by having a height of less than 5 inches, and a diameter of less than 6 inches.

14. The multi-purpose tiered base in claim 10, further characterized by a rectangle shape of the outside edge of the layers.

15. The multi-purpose tiered base in claim 14, further characterized by having a height of less than 5 inches, and a diameter of less than 6 inches.

16. The multi-purpose tiered base in claim 9, wherein the shape of the plurality of layers includes round, oval, rectangle, heart, octagon or any custom shape, and that the base may include layers that are constructed all in the same shape or any combination of these.

17. The multi-purpose tiered base in claim 9, wherein the base also comprises one or more layers that are in the same size as another layer, rather than diminishing in size so that extra height may be added to a tier, rather than creating another tier.
